(19) United States
(12) Patent Application Publication
(10) Pub. No.: US 2024/0424697 A1
(43) Pub. Date: Dec. 26, 2024

(54) KNIFE

(71) Applicant: KAI R&D CENTER CO., LTD., Seki-shi (JP)

(72) Inventors: Junji MISHINA, Seki-shi (JP); Toshiya NAKAMURA, Seki-shi (JP); Hironobu TSUKIMOTO, Seki-shi (JP); Koichi MOMOSE, Seki-shi (JP)

(21) Appl. No.: 18/819,894

(22) Filed: Aug. 29, 2024

Related U.S. Application Data
(63) Continuation of application No. PCT/JP2023/005552, filed on Feb. 16, 2023.

(30) Foreign Application Priority Data
Mar. 28, 2022 (JP) 2022-052139

(51) Int. Cl. B26B 3/02; B25G 3/34

(52) U.S. Cl. CPC B26B 3/02; B25G 3/34

(57) ABSTRACT

An edged tool according to the present disclosure includes: a blade, at a rear end portion thereof, divided in a thickness direction and provided with a space open at the rear end side; and a handle gripped by a user.

### CROSS-REFERENCE TO RELATED APPLICATIONS

This application is a continuation of International Application No. PCT/JP2023/005552, filed Feb. 16, 2023, which claims priority to Japanese Application No. 2022-052139, filed Mar. 28, 2022, which are incorporated by reference herein in their entireties.

### TECHNICAL FIELD

One aspect of the present disclosure relates to an edged tool.

### BACKGROUND ART

Conventionally, configuration of kitchen knives having a bolster has been adopted such that a blade is inserted into a slit provided in the bolster and then welded to connect the bolster and the blade to each other. Patent Document 1 discloses a method of manufacturing an edged tool by welding a blade and a bolster to each other, and after the welding, polishing the blade portion and attaching a handle (paragraph 0009 etc.).

### CITATION LIST

### Patent Document

Patent Document 1: Japanese Patent Application Laid-open No. H05-038570

### SUMMARY

### Technical Problem

However, in the conventional configuration in which the bolster and the blade are welded to each other, it is necessary to polish a portion where the blade and the bolster are welded, which may reduce a plate thickness of the blade of the welded portion and may reduce a strength of the assembled kitchen knife. It is required an edged tool of the same configuration as that having a blade and a bolster, which does not need to polish the blade even when the blade and the bolster are bonded to each other.

### Solution to Problem

In order to solve the above-described problems, the disclosure provides an edged tool storage device with the following means.

An edged tool according to one aspect of the present disclosure includes; a blade, at a rear end portion thereof, divided in a thickness direction and provided with a space open at the rear end side; and a handle gripped by a user.

In accordance with the edged tool having the above-described configuration, it is possible to achieve a configuration equivalent to that including a bolster, without providing a bolster, and therefore it is unnecessary to weld and polish the portion between the blade and the bolster. It is also possible to achieve a configuration provided with a blade having high strength so that the blade is not partially thinned due to polishing.

In the above-described edged tool, the space may be formed by bonding a blade side end portion and a back side end portion at the rear end portion of the blade divided in the thickness direction.

In accordance with the edged tool of the above-described configuration, the space formed integrally with blade can be provided at the rear end portion of the blade with a relatively simple configuration.

In the above-described edged tool, the handle may be configured to being connected to the blade via the space.

In accordance with the edged tool of the above-described configuration, the blade and the handle can be configured to be connect to each other without welding or the like, merely with a relatively simple configuration.

In the above-described edged tool, the handle may be a portion of the blade in which the space is provided.

In accordance with the edged tool of the above-described configuration, it can be configured to have the handle that is integrally formed with the blade and is easy to grip.

In the above-described edged tool, it may be configured to further include a connecting member provided at the rear end portion and having a connecting mechanism at a rear end thereof, in which the handle is connected to the blade via the connecting member.

In accordance with the edged tool of the above-described configuration, it can be configured to provide the connecting member instead of the bolster, and the strength of the edged tool can be unaffected even when the connecting portion is welded and polished to be thinner as conventional example.

In the above-described edged tool, it may be configured so that a side surface of the blade is a continuous surface from a cutting edge to the rear end portion, and the rear end portion is spread in the thickness direction.

### BRIEF DESCRIPTION OF DRAWINGS

FIG. 1 is a perspective view of a blade after a space forming process in an embodiment 1.

FIG. 2 is a perspective view in a state where a connecting member is attached to the blade after the space forming process, in the embodiment 1.

FIG. 3 is an exploded cross-sectional view of a kitchen knife, including the blade and a handle, in the embodiment 1.

FIG. 4 is a perspective view of the blade before the space forming process, in the embodiment 1.

FIG. 5 is an enlarged view of a rear end portion of the blade divided in a thickness direction, in the embodiment 1.

FIG. 6 is an enlarged view of the rear end portion of the blade to which a connecting member is attached after the space forming process, in the embodiment 1.

FIG. 7 is an enlarged view of the connecting portion between the blade and the bolster, in a kitchen knife of the comparative example.

FIG. 8 is a perspective view of the blade after the space forming process, in an embodiment 2.

FIG. 9 is a perspective view in a state where a connecting member is attached to the blade after the space forming process, in the embodiment 2.

FIG. 10 is an enlarged view of the rear end portion of the blade to which a connecting member is attached after the space forming process, in the embodiment 2.

### DESCRIPTION OF EMBODIMENTS

An edged tool of one aspect of the present disclosure has a nonconventional configuration of providing, at a rear end portion of a blade, a space formed to be divided in a thickness direction of the blade and opened to a rear end side. The edged tool of such an aspect has sufficient strength since a bonded portion between the blade and a bolster is not polished to make the bonded portion of the blade thin.

Hereinafter, a kitchen knife of one aspect of the edged tool according to the present disclosure will be specifically explained, with reference to the drawings. However, the embodiments described in the following are merely examples of the present disclosure, and do not intend the technical range of the present disclosure to be restrictively interpreted. It is to be noted that, in each drawing, the same components are represented with the same reference signs.

### Embodiment 1

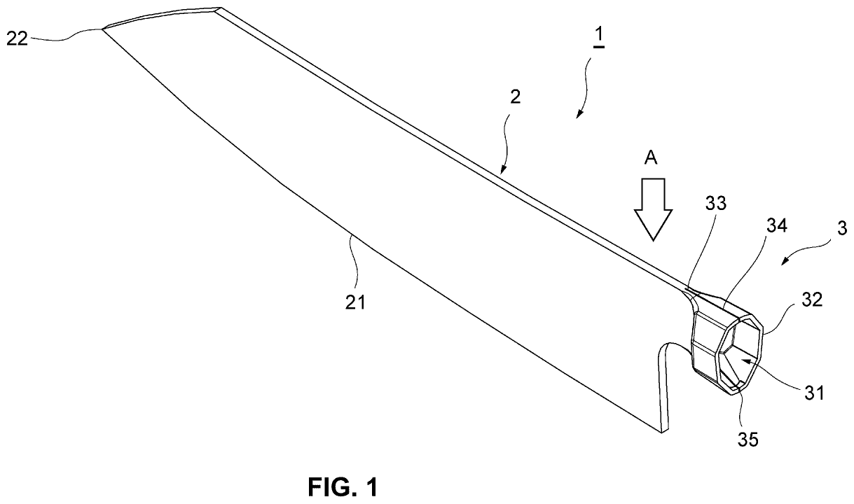

FIG. 1 is a perspective view of a blade 2 in which a space 31 is provided at a rear end portion 3, in a kitchen knife 1 according to an embodiment 1 of the present disclosure.

The blade 2 is made of a metal such as a stainless steel, and is formed by punching from a plate material, forging, or the like. A space 31 is formed at a rear end portion 3 of the blade 2 through a space forming process described below. The blade 2 has an end surface 21 on the blade side is ground and polished to form a knife point. There is a cutting edge 22 at a tip of the blade 2, and the rear end portion 3 is provided at a rear end of the blade.

A rear end surface 32, which is a surface on a rear end side of the rear end portion 3, is a rounded octagonal annulus, viewed from the rear end side, and a center portion thereof is a grooved hollow to form the space 31. In other words, the space 31 is open at the rear end side in the rounded octagonal shape. The blade 2 is a shape spreading in the thickness direction from an expansion starting point 33 positioned at the rear end side to the rear end surface 32, and inside of this portion spreading in the thickness direction is formed as the space 31. It is to be noted that the rear end surface 32 does not necessarily have to be an octagonal annulus, but may be a polygonal annulus, or a circular or oval annulus, or any other shape.

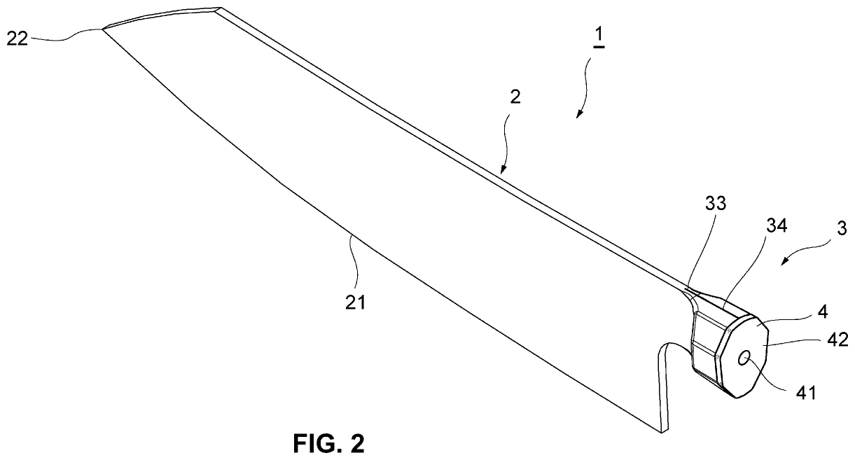

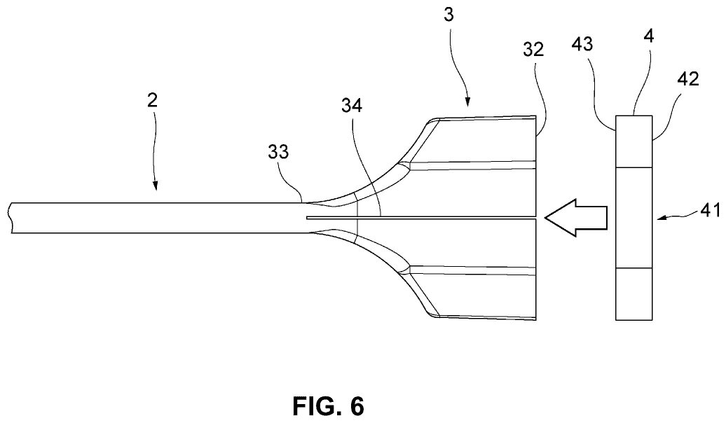

FIG. 2 is a perspective view in a state where a connecting member 4 is attached to the blade 2. FIG. 6 is an enlarged view of a portion around the rear end portion 3 where the connecting member 4 is attached to the blade 2, viewed from the back side as indicated by the arrow A in FIG. 1. As illustrated in FIGS. 2 and 6, the plate-shaped connecting member 4 is bonded to the rear end portion 3 of the blade 2.

The connecting member 4 is made of a metal different from that of the blade 2, and a shape of the connecting member 4 viewed from the rear end side is a rounded octagonal shape similar to an outer edge of the shape of the rear end portion 3 of the blade 2 viewed from the rear end side. In other words, the connecting member 4 is shaped as a cover for covering the space 31 of the blade 2. The connecting member 4 includes a female screw portion 41 formed to pass through from the rear end surface 42 to the front end surface 43. The front end surface 43 of the connecting member 4 is in contact with the rear end surface 32 of the blade 2 and is bonded thereto by welding or the like. The blade 2 and the connecting member 4 may be bonded such as by welding the contact portion therebetween from the outside. As illustrated in FIG. 6, a back side bonded portion 34 formed by bonding in a space forming process described below is provided on the back side of the rear end portion 3. Similarly, a blade side bonded portion 35 is provided on the blade side of the rear end portion 3. These welded portions may be polished, and even when the welded portions are polished, the blade itself is not thinner and the strength thereof is not reduced. The connecting member 4 may be formed of the same metal as the blade 2.

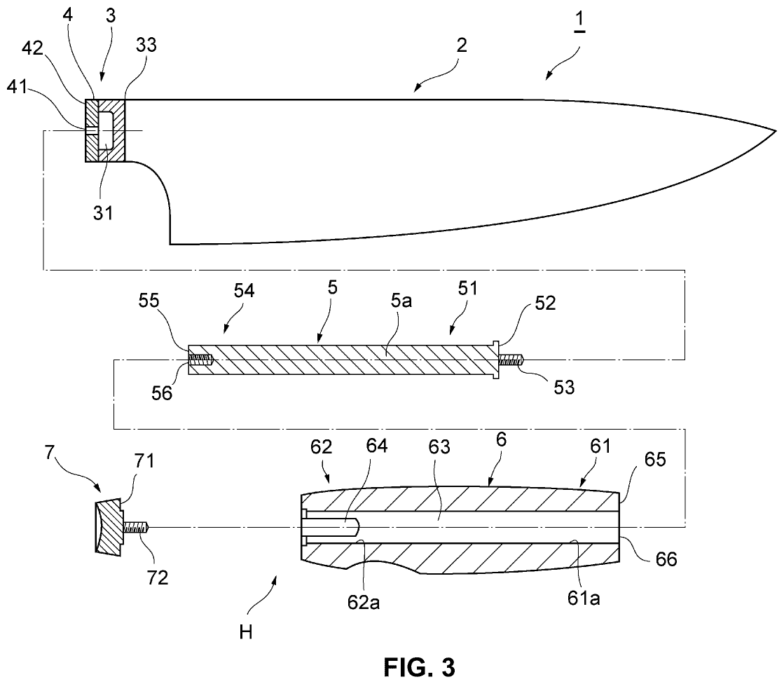

FIG. 3 is an exploded cross-sectional view illustrated by decomposing the kitchen knife 1 including the blade 2. However, the blade 2 except for the rear end portion 3 is illustrated in side view, not in cross section. As illustrated in FIG. 3, the kitchen knife 1 is made of the blade 2, the connecting member 4, a core shaft 5, a gripping portion 6, and a bottom cover 7. A handle H of the kitchen knife 1 is formed by attaching the core shaft 5, the gripping portion 6, and the bottom cover 7 to the connecting member 4 of the blade 2. The handle H is also referred to as “haft”. It is to be noted that the configuration described here is merely one example of the configuration of the handle H, but a handle H having a configuration different from that described herein may be used as long as it can be gripped by a user when using the kitchen knife 1.

The core shaft 5, which is a core on a shaft, is made of a metal or a synthetic resin, and is formed through a machine cutting process or molding. A male screw portion 53 is integrally formed at an end surface 52 of the core shaft 5 so as to protrude. The core shaft 5 has a circular cross section centering around a center line 5a ranging from a head portion 51 to a bottom portion 54. A female screw portion 56 is formed in an end surface 55 of the core shaft 5. When the male screw portion 53 of the head portion 51 of the core shaft 5 is screwed into the female screw portion 41 of the connecting member 4 of the blade 2, the end surface 52 of the head portion 51 is in a state of in contact with the rear end surface 42 of the connecting member 4, the core shaft 5 is in a state of being extended from the connecting member 4.

The gripping portion 6 is molded from a synthetic resin or the like. In the gripping portion 6, a through hole 63 having a circular cross section is formed ranging from a head portion 61 to a bottom portion 62. An inner periphery 62a of the bottom portion 62 is cut out on both the left and right sides in a planar shape so as to form a restriction surface 64 for restricting rotation of the core shaft 5 inside the gripping portion 6. An inner diameter of the inner periphery 61a of the head portion 61 is larger than an inner diameter of the inner periphery 62a of the bottom portion 62.

When the core shaft 5 is inserted into the through hole 63 in the gripping portion 6 from the head portion 61 side and the gripping portion 6 is attached to the outer periphery of the core shaft 5, a movement restriction mechanism holds the core shaft 5 in a state where its movement is restricted with respect to the gripping portion 6.

The bottom cover 7 is made of a metal, a synthetic resin, or the like, and is formed of a machine cutting process or a molding. A male screw portion 72 is formed in an end surface 71 of the bottom cover 7. When the male screw portion 72 is screwed into the female screw portion 56 of the bottom portion 54 of the core shaft 5, it is in a state where the bottom cover 7 and the core shaft 5 connected to each other. When the bottom cover 7 is rotated and the screw thread is tightened, the gripping portion 6 is fastened between the bottom cover 7 and the connecting member 4.

### Space Forming Process

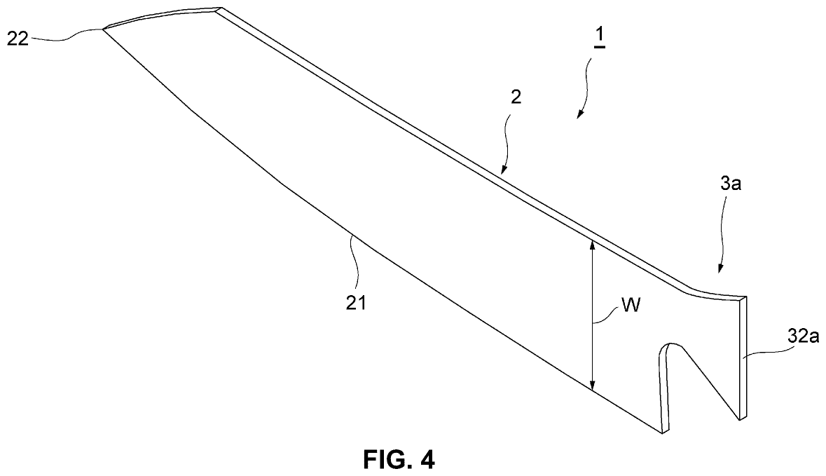

Next, the space forming process for forming the space 31 in the rear end portion 3 of the blade 2 will be described. FIG. 4 is a perspective view of the blade 2 before the space forming process. Before the space forming process is applied, the blade 2 is an entirely metal plate material having a planar shape. The rear end portion 3a before the space forming process of the blade 2 extends in a planar view in a width direction W, i.e., back side and blade side directions.

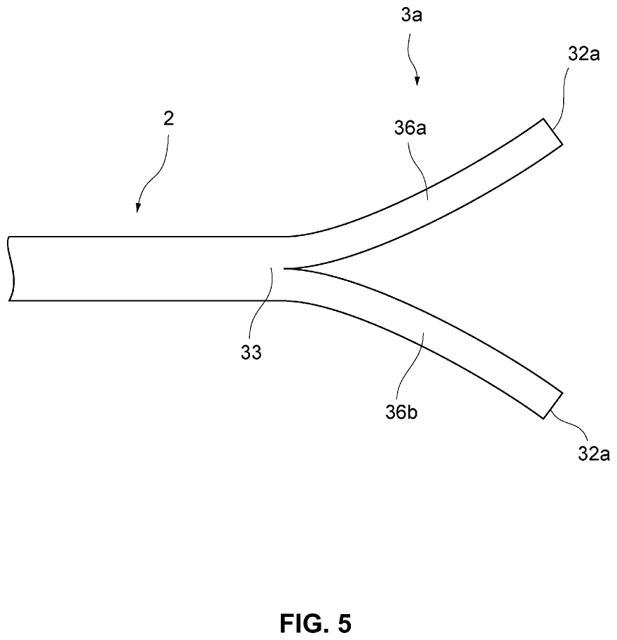

In the space forming process, the blade 2 is first divided in the thickness direction from the rear end surface 32a toward the front, i.e., toward the cutting edge 22. At this time, the blade 2 is divided in its entire width direction. FIG. 5 is an enlarged view of the rear end portion 3a of the blade 2 divided in the thickness direction. As illustrated in FIG. 5, the blade 2 is divided in the thickness direction in a region from the rear end surface 32a to the expansion starting point 33, and the rear end portion 3a of the blade 2 is divided into a first rear end portion 36a and a second rear end portion 36b. A thickness of each of the first rear end portion 36a and the second rear end portion 36b is approximately half the plate thickness of blade 2 before it is divided.

Next, a distance between the first rear end portion 36a and the second rear end portion 36b is adjusted by applying a drawing process or the like to the rear end portion 3a from the rear end side. Next, the first rear end portion 36a and the second rear end portion 36b are bonded by welding or the like at the back side end surface and the blade side end surface so that the rear end surface 32a is processed to form a rounded octagonal annulus. At this time, as illustrated in FIGS. 6 and 1, the back side bonded portion 34 is formed on the back side end portion, and the blade side bonded portion 35 is formed on the blade side end portion. Consequently, the rear end portion 3 divided in the thickness direction and having the space 31 open to the rear end side is formed in the rear end of the blade 2. The rear end surface 32 of the rear end portion 3 after the space forming process has a rounded octagonal annulus as described above.

FIG. 6 is an enlarged view of a portion around the rear end portion 3 of the blade 2 when the connecting member 4 is attached thereto after the space forming process, viewed from the back side as indicated by the arrow A in FIG. 1. The above-described back side bonded portion 34 is formed to be bonded to rear end portion 3 during the space forming process. The rear end portion 3 has a shape in which the rear end side is expanded in the thickness direction of the blade 2 more than the expansion starting point 33 in a planar view, observed from the back side. The connecting member 4 is bonded to the rear end portion 3 by welding or the like so that the front end surface 43 of the connecting member 4 is in contact with the rear end surface 32.

In the blade 2 according to the present embodiment, since the space 31 is formed by such a space forming process, the side surface of the blade 2 is formed as a continuous surface ranging from the cutting edge to the rear end portion 3 without a bonded portion or the like being formed.

Comparison with Structure of Comparative Example

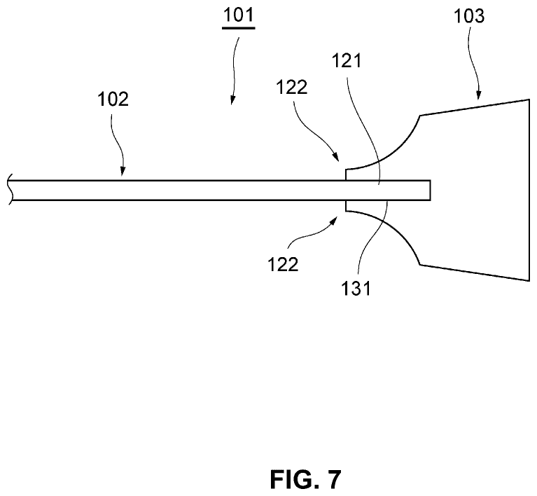

FIG. 7 is a partially enlarged view of a kitchen knife 101 including a blade 102 and a bolster 103, as a comparative example. In this comparative example, the blade 102 is in the form of a plate that is not subjected to the space forming process. A grooved slit 131 is formed in the bolster 103. A rear end portion 121 of the blade 102 is inserted into the slit 131 of the bolster 103 and is welding at a welded portion 122, thereby bonding the blade 102 and the bolster 103 to each other. Thereafter, the welded portion 122 can be polished in order to adjust a shape and remove any raised weld marks on a surface, and thereby the blade 102 becomes partially thinner than the base material of the blade 102 in the vicinity of the welded portion 122.

In contrast, in the kitchen knife 1 of the present embodiment illustrated in FIGS. 1 to 6, there is no need to polish the blade 2 so as to reduce the plate thickness thereof, as in the above-described comparative example. Accordingly, the kitchen knife 1 according to the present embodiment has configuration provided with the blade 2 having higher strength as compared with the comparative example. Moreover, if there is a portion in which the plate thickness of the blade is thin, a stress may be concentrated on this portion, and in some cases, the blade may break, but the blade 2 in the embodiment 1 does not reduce the plate thickness and is therefore less likely to break.

Moreover, the bolster 103 in the comparative example usually is made of a softer material as compared with the stainless steel or the like, that is a material of the blade 102. In contrast, in the embodiment 1, the rear end portion 3 is integral with the blade 2 and is therefore formed from the same hard stainless steel as the blade 2. Therefore, the bolster 103 in the comparative example needs to be solid in order to maintain its strength, but the rear end portion 3 of the kitchen knife 1 in embodiment 1 can be made sufficiently strong even when the hollow structure having the space 31 is adopted. Furthermore, in the kitchen knife 1 in the embodiment 1, the hollow structure is adopted, thereby making it possible to reduce the weight as compared with the solid structure such as the bolster 103 in the comparative example.

Grooved concavity and convexity may be formed on the rear end portion 3 of the blade 2. A shape of the concavity and convexity may be freely determined. As described above, the blade 2 in the present embodiment is formed from a hard material, so that it can maintain sufficient strength even when such concavity and convexity are formed. On the other hand, when such concavity and convexity is formed, the concavity and convexity is formed just where a user grips it, thereby preventing the kitchen knife 1 from slipping.

### Embodiment 2

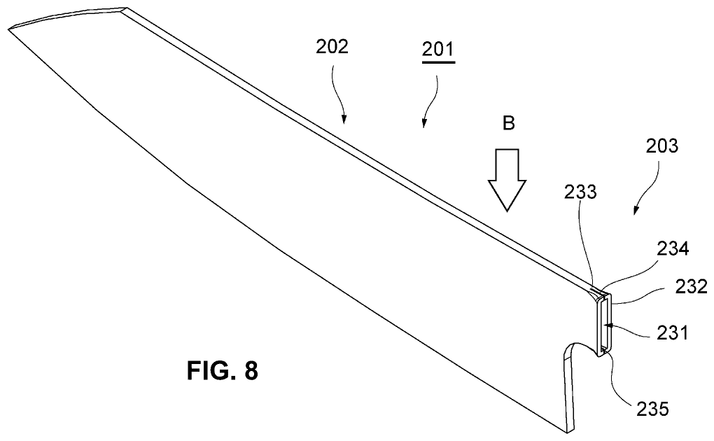

Next, a kitchen knife 201 according to an embodiment 2 of the present disclosure will be described with reference to FIGS. 8 to 10. Since the present embodiment has some configurations and features in common with the embodiment 1, the following description will focus on the differences from the embodiment 1 and omits a description of the commonalities with the embodiment 1.

FIG. 8 is a perspective view of a blade 202 in which a space 231 is provided at a rear end portion 203, in a kitchen knife 201 according to an embodiment 2 of the present disclosure.

The blade 202 is made of a metal such as a stainless steel, and is formed by punching from a plate material, forging, or the like. The space 231 is formed in the blade 202 through the space forming process. The rear end portion 203 is provided at a rear end of the blade 202.

The rear end surface 232, which is a surface on a rear end side of the rear end portion 203, is a rounded rectangular annulus, and a center portion thereof is a grooved hollow to form the space 231. In other words, the space 231 is open at the rear end side in the rounded rectangular shape. The blade 202 is a shape spreading in the thickness direction from an expansion starting point 233 positioned at the rear end side to the rear end surface 232, and inside of this portion spreading in the thickness direction is formed as the space 231.

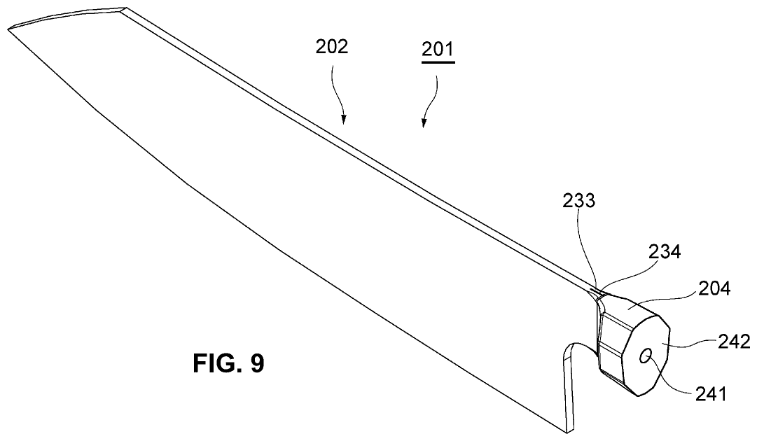

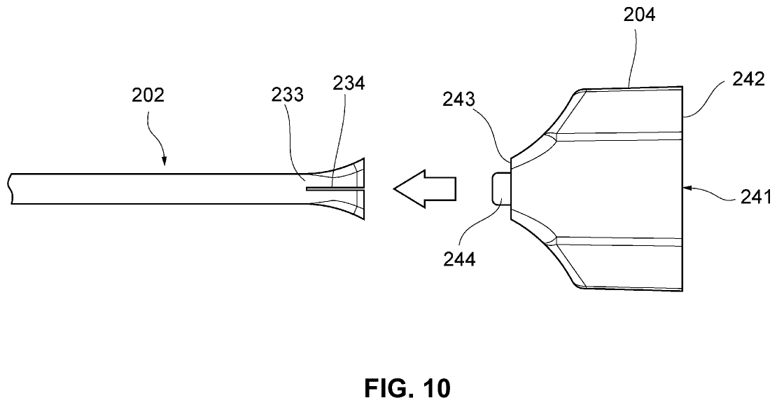

FIG. 9 is a perspective view in a state where a connecting member 204 is attached to the blade 202. FIG. 10 is an enlarged view of a portion around the rear end portion 203 where the connecting member 204 is attached to the blade 202, viewed from the back side as indicated by the arrow B shown in FIG. 8. The connecting member 204 having the shape as illustrated in FIGS. 9 and 10 is bonded to the rear end portion 203 of the blade 202. It is to be noted that the connecting member 204 is not limited to such a shape, but may be of any other shape as long as it can be interposed in the connection between the handle and the blade 202. It is also possible to adopt a configuration in which the blade 202 and the handle is connected to each other without the connecting member 204 being interposed therebetween.

The connecting member 204 is made of a metal different from that of the blade 202. The connecting member 204 viewed from the rear end side has a rounded octagonal shape. The connecting member 204 includes a female screw portion 241 formed in a groove shape from the rear end surface 242. The connecting member 204 includes, on the front end surface 243, a protrusion 244 protruded from the front end surface 243. The protrusion 244 is inserted into the space 231 of the blade 202, and a portion where the rear end surface 232 of the blade 202 is in contact with the front end surface 243 of the connecting member 204 is welded etc., to bond the blade 202 and the connecting member 204 to each other. As illustrated in FIG. 10, a back side bonded portion 234 formed by bonding in the space forming process is provided on the back side of the rear end portion 203. Similarly, a blade side bonded portion 235 is provided on the blade side of the rear end portion 203. The connecting member 204 may be formed of the same metal as the blade 202.

The space 231 is formed at the rear end portion 203 of the blade 202 in the embodiment 2 by a space forming process similar to the space forming process described in the embodiment 1. In the blade 202 in the embodiment 2, a region to be divided is smaller than that of the blade 2 in the embodiment 1.

### Modified Examples

The edged tool according to the present disclosure, including the blade having the space provided at the rear end portion is not limited to the aspects as the above-described embodiments, and configurations of, for example, the following modified examples can also be adopted.

For example, in a kitchen knife as a modified example, the rear end portion of the blade may be functioned as the handle as it is. In the blade forming such a kitchen knife, sufficiently longer space is formed in a longitudinal direction than that of the embodiment 1 at the rear end portion by using, for example, the vicinity of the center in longitudinal direction of the plate material, that serves as a base material, as an expansion starting point. In accordance with such an aspect, in the blade, the rear end portion where the space is provided can be functioned as the handle.

Moreover, in the blade in the kitchen knife as the modified example, in the space forming process, instead of the entire blade in the width direction, the blade may be divided except at both ends in the width direction of the blade. In this way, the space can be formed in a rear end portion of a blade, without forming the back side bonded portion and blade side bonded portion obtained by bonding the back side thereof and blade side thereof.

Although the connecting member 4 and the like in the embodiments has the configuration in which the blade and the handle are connected to each other by screwing the screw thread, the blade and the handle may be connected to each other by a means other then the screwing of the screw thread. In this case, the connecting member 4 and the like has a configuration provided with a connecting mechanism other than the screw hole.

Moreover, the same configuration as that of the above-described embodiments may be adopted also into edged tools except the kitchen knife.

### Features of Present Embodiments

The kitchen knives, which are also examples of knives, described in the embodiments 1, 2 and modified examples have the following features, for example.

The kitchen knife 1 in the embodiment 1 includes the blade 2 and the handle H. The blade 2 is, at the rear end portion 3, divided in the thickness direction and is provided with the space 31 and open to the rear end side. A user can grip the handle H. The kitchen knife 201 in the embodiment 2 has also the similar configuration.

In accordance with such configuration, it is possible to achieve a configuration equivalent that including the bolster without providing the bolster as conventional. Accordingly, the kitchen knife 1 including the blade having high strength is obtained, in which the welding and polishing between the blade and the bolster are no longer necessary, and the blade does not become partially thin due to the polishing.

In the kitchen knife 1 of the embodiment 1, at the rear end portion 3 of the blade 2 divided in the thickness direction where the space 31 is formed, the back side and the blade side are respectively bonded to form the back side bonded portion 34 and the blade side bonded portion 35. The kitchen knife 201 in the embodiment 2 has also the similar configuration.

In accordance with such an edged tool, the space 31 formed integrally with blade 2 can be provided at the rear end portion 3 of the blade 2 with a relatively simple configuration.

In the kitchen knife 1 in the embodiment 1, the handle H is connected to the blade 2 via the space 31. The aspect of the connection is not limited to the configurations in the embodiments, but it is arbitrary. For example, the handle H may be connected to the blade 2 by a configuration etc. in which the male screw portion 53 of the core shaft 5 is screwed into the female screw portion 41 of the connecting member 4. The kitchen knife 201 in the embodiment 2 may have also the similar configuration.

In accordance with such an edged tool, the blade 2 and the handle H can be configured to be connect to each other without welding or the like, merely with a relatively simple configuration.

Moreover, as described in the modified example, the blade may also be as edged tools, such as a kitchen knife in which the rear end portion where the space is provided is functioned as the handle. In accordance with such an edged tool, it can be configured to have the handle that is integrally formed with the blade and is easy to grip.

Moreover, in the kitchen knife 1 in the embodiment 1, the connecting member 4 is provided at the rear end portion 3. The female screw portion 41 functioned as the connecting mechanism with the handle H is provided at the rear end surface 42 of the connecting member 4. The handle H is connected to the blade 2 via the connecting member 4. The kitchen knife 201 in the embodiment 2 has also similar configuration. The connecting mechanism is not necessarily limited to the screw thread.

In accordance with such an edged tool, it can be configured to provide the connecting member 4 instead of the conventional bolster, and the strength of the edged tool can be unaffected even when the connecting portion is welded and polished to be thinner as conventional example.

Moreover, in the kitchen knife 1 in the embodiment 1, the side surface of the blade 2 is a continuous surface all over from the cutting edge 22 to the rear end portion 3, and the rear end portion 3 has the configuration of being spread in the thickness direction.

### Reference Signs List

1, 201 Kitchen knife
2, 202 Blade
3, 3a, 203 Rear end portion
31, 231 Space
32, 32a, 232 Rear end surface
33, 233 Expansion starting point
34, 234 Back side bonded portion
35, 235 Blade side bonded portion
4, 204 Connecting member
41, 241 Female screw portion
42, 242 Rear end surface
43, 243 Front end surface
244 Protrusion
5 Core shaft
6 Gripping portion
7 Bottom cover
H Handle

1. An edged tool comprising:
a blade, at a rear end portion thereof, divided in a thickness direction and provided with a space open at the rear end side; and
a handle gripped by a user.

2. The edged tool according to claim 1, wherein the space is formed by bonding a blade side end portion and a back side end portion at the rear end portion of the blade divided in the thickness direction.

3. The edged tool according to claim 1, wherein the handle is connected to the blade via the space.

4. The edged tool according to claim 1, wherein the handle is a portion in which the space of the blade is provided.

5. The edged tool according to claim 1, further comprising a connecting member provided at the rear end portion and having a connecting mechanism at a rear end thereof, wherein the handle is connected to the blade via the connecting member.

6. The edged tool according to claim 1, wherein a side surface of the blade is a continuous surface from a cutting edge to the rear end portion, and the rear end portion is spread in the thickness direction.
